(19) United States
(12) Patent Application Publication
(10) Pub. No.: US 2016/0026402 A1
(43) Pub. Date: Jan. 28, 2016

(54) SYSTEM AND METHOD FOR PROVIDING CONSISTENT, RELIABLE, AND PREDICTABLE PERFORMANCE IN A STORAGE DEVICE

(71) Applicant: NXGN DATA, INC., Irvine, CA (US)

(72) Inventors: Joao Alcantara, Irvine, CA (US); Ricardo Cassia, Rancho Santa Margarita, CA (US); Kamyar Souri, San Jose, CA (US); Vladimir Alves, Tustin, CA (US); Guangming Lu, Irvine, CA (US)

(21) Appl. No.: 14/806,074

(22) Filed: Jul. 22, 2015

Related U.S. Application Data
(60) Provisional application No. 62/027,666, filed on Jul. 22, 2014.

(51) Int. Cl. G06F 3/06

(52) U.S. Cl. CPC G06F 3/0619; G06F 3/0653; G06F 3/0679

(57) ABSTRACT

The solution described here is a method to provide consistent performance in a storage device. A performance manager module is implemented to measure the time interval in which a command takes to be completed. In case the time interval is longer than a certain threshold, the difference is annotated and used on the consecutive commands within a programmable time window. This time window can be a regular time interval e.g. every second. In case the time interval is shorter than a threshold, the control module delays sending the command completion to the host until the threshold value is reached. The delay is adjusted based on the credit annotation due to commands that took longer than the time interval to be completed in order to compensate for commands that took longer than the threshold to complete, during a certain time window.

### CROSS-REFERENCE TO RELATED APPLICATION(S)

The present application claims priority to and the benefit of U.S. Provisional Application No. 62/027,666, filed Jul. 22, 2014, entitled “SYSTEM AND METHOD FOR PROVIDING CONSISTENT, RELIABLE, AND PREDICTABLE PERFORMANCE IN A STORAGE DEVICE”, the entire content of which is incorporated herein by reference.

### FIELD

One or more aspects of embodiments according to the present invention relate to a system and method for providing consistent, reliable, and predictable performance in a storage device.

### BACKGROUND

Most SSDs today are designed to provide the best performance at any given time. This usually results in a considerable variation in performance as consequence of changes on the system state. For example, a brand new SSD (clean state) usually presents a very high performance before being pre-conditioned. The preconditioning process writes the entire drive (full state) and forces that any new host write commands require garbage collection tasks to be performed. This represents a problem for some applications which require that the drive performance must be stable and not vary more than a certain percentage of the average value. The performance is measured over a certain time window.

One patent that discloses an approach to address the performance variability is US 20140075105 A1. This approach solves the problem of the performance consistency at the system level. An I/O scheduler is configured to receive read and write requests and schedule the read and write requests for processing by a plurality of storage devices. The storage devices may exhibit varying latencies depending upon the operations being serviced, and may also exhibit unscheduled or unpredicted behaviors at various times that cause performance to vary from the expected or desired. In various embodiments these behaviors correspond to behaviors in which the devices are functioning properly (i.e., not in an error state), but are simply performing at a less than expected or desired level based on latencies and/or throughput. Such behaviors and performance may be referred to as “variable performance” behaviors. These variable performance behaviors may, for example, be exhibited by technologies such as flash based memory technologies. This solution does not address the problem of the performance variation within the storage device.

### SUMMARY

Aspects of embodiments of the present disclosure are directed toward a system and method for providing consistent, reliable, and predictable performance in a storage device.

### BRIEF DESCRIPTION OF THE DRAWINGS

These and other features and advantages of the present invention will be appreciated and understood with reference to the specification, claims and appended drawings wherein:

FIG. 1 is a block diagram of an SSD device in communication with a host according to an embodiment of the present invention;

FIG. 2 is a block diagram of a performance manager module, according to an embodiment of the present invention;

FIG. 3 is a flow chart showing the drive characterization flow which determines the threshold values for commands, according to an embodiment of the present invention;

FIG. 4 is a flow chart showing the flow of a command using a performance manager according to an embodiment of the present invention;

FIG. 5 is a flow chart showing the flow of a command using a performance manager according to an embodiment of the present invention; and

FIG. 6 is a flow chart of a command flow according to an embodiment of the present invention.

### DETAILED DESCRIPTION

The detailed description set forth below in connection with the appended drawings is intended as a description of exemplary embodiments of a system and method for providing consistent, reliable, and predictable performance in a storage device provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

The solution described here is a method to provide consistent performance in a storage device. A performance manager module is implemented to measure the time interval in which a command takes to be completed. In case the time interval is longer than a certain threshold, the difference is annotated and used on the consecutive commands within a programmable time window. This time window can be a regular time interval e.g. every second. In case the time interval is shorter than a threshold, the control module delays sending the command completion to the host until the threshold value is reached. The delay is adjusted based on the credit annotation due to commands that took longer than the time interval to be completed in order to compensate for commands that took longer than the threshold to complete, during a certain time window. The threshold value is programmable and may have different values for read and write commands. The threshold value can be used to control the performance in the storage device. The performance manager module notifies if the performance within the time window varies more than a certain percentage of the desired performance. The mechanism can also be used to eliminate the necessity of pre-conditioning a SSD to be able to analyze the performance if the programmed threshold uses a value related to the worst performance number, i.e., after pre-conditioning a drive.

### Keywords

Garbage Collection—algorithm used to pick the next best block to erase and rewrite

Pre-conditioning—filling an empty drive with host data, and consequently new write will trigger garbage collection tasks.

IOPS—Number of I/O operations per second

RAID—Redundant Array of Inexpensive Drives/Devices

DRAM—Dynamic Random Access Memory

SoC—System on a Chip

SSD—Solid State Drive

The SSD products are employed in a number of form factors and tuned for several different applications. Some applications require the storage device to provide consistent performance throughout its lifetime, this can be difficult to achieve since SSDs have a pronounced write-history sensitivity. Our solution is a method for providing consistent, reliable and predictable performance regardless the SSD operation state.

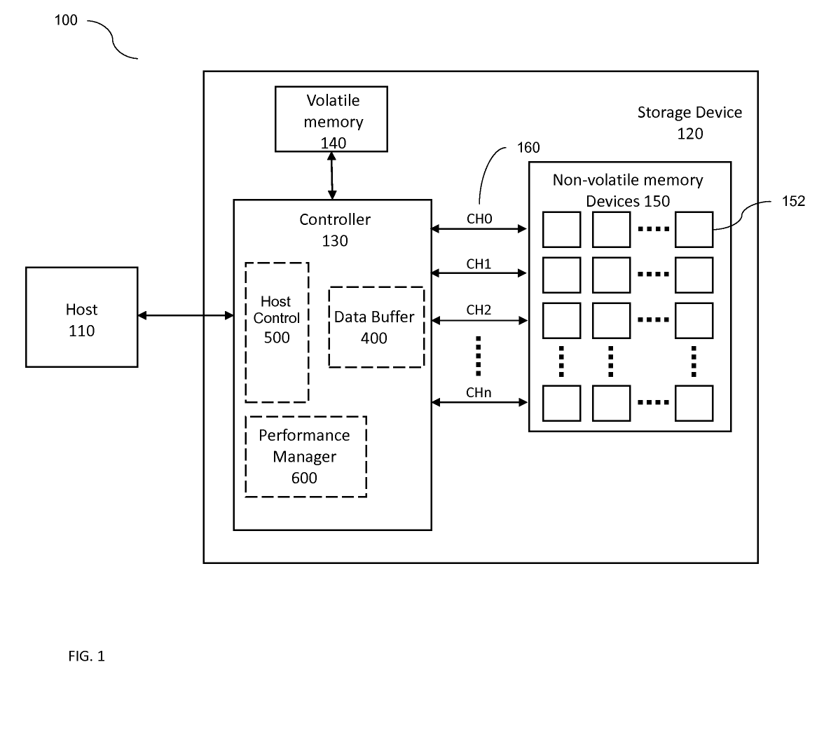

FIG. 1 shows a SSD device in communication with a host.

Host 110 sends commands to the SSD 120. These host commands can be related to read or write operations to the media; in the case of a SSD, the non-volatile memory 150. The host commands are processed by the host control block 500. The number of read or write commands a storage device can execute per unit of time determines its performance. If this number varies over time depending on the state of the drive this translates directly to a variation of the drive performance. For example, for a write command, if the drive is empty, any host write command does not trigger any data movement in media due to garbage collection, translating to a short time interval for command completion. As the storage device is being written to, its behavior changes because of background tasks involving data movement to/from the NVM media (garbage collection). This change in the drive behavior will affect the time it takes to complete host commands and therefore will alter its performance as seen by the host 110.

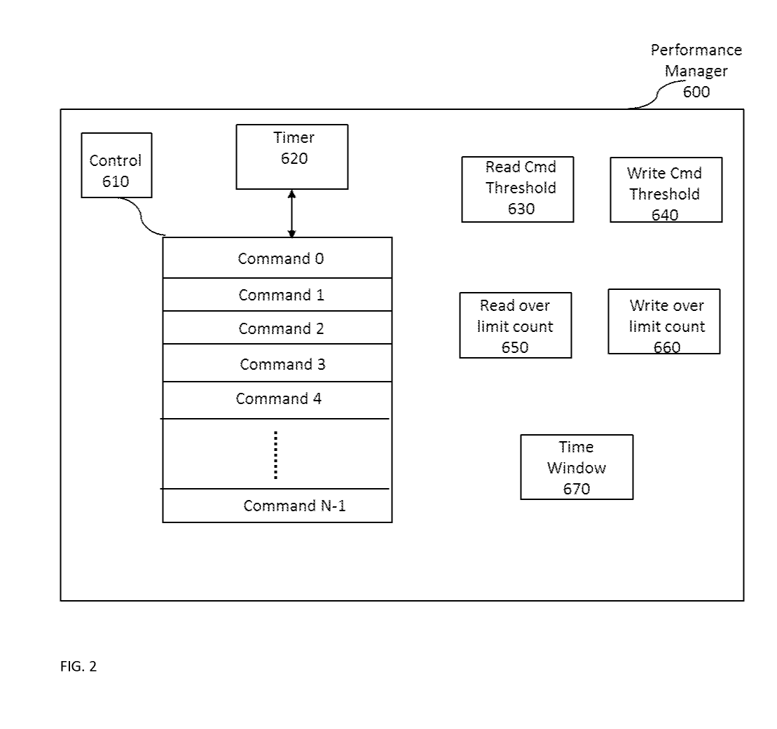

This invention adds an additional step before the storage device sends the completion of any read or write command to the host 110. This additional step is based on the information provided by the performance manager module 600. The block diagram of FIG. 2 shows details of the performance manager module 600.

In one embodiment, the performance manager module 600 contains a counter for each command being processed by the drive. For example, if the drive can handle up to 128 queued commands, control block 610 will contain 128 counters. Block 610 also stores the threshold index associated with the command and all control bits necessary to keep track of the command and the communication with the Host Control. The counters keep track of the time interval for each of the commands currently been processed by the drive.

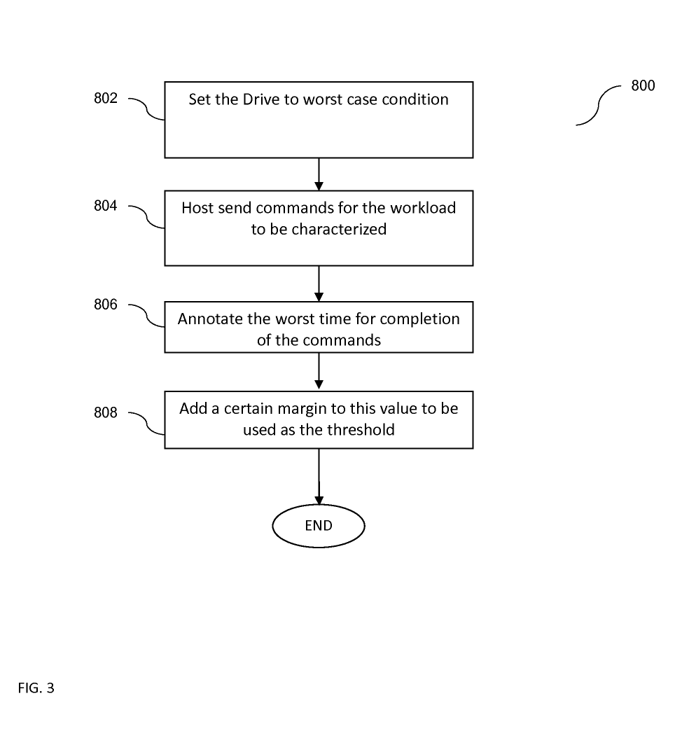

The performance manager module contains two register banks to store the threshold values depending on the command size that indicates the ideal time interval which the completion can be sent to host, depicted in blocks 630 and 640. The diagram of FIG. 3 shows the flow of the drive characterization 800 which determines the threshold values for the commands.

The characterization process includes setting the drive to the worst case condition, step 802, i.e., the number of program/erase cycle associated with the end of life of the memory devices 150. Host sends commands that match the workload to be characterized, at step 804. The controller annotates the worst case time for completion of the commands, step 806. The controller uses this value, added to a certain margin, as the threshold value to be stored in blocks 630 and 640.

In one embodiment, the threshold value is the worst time interval that a command can be completed which is determine during the drive characterization.

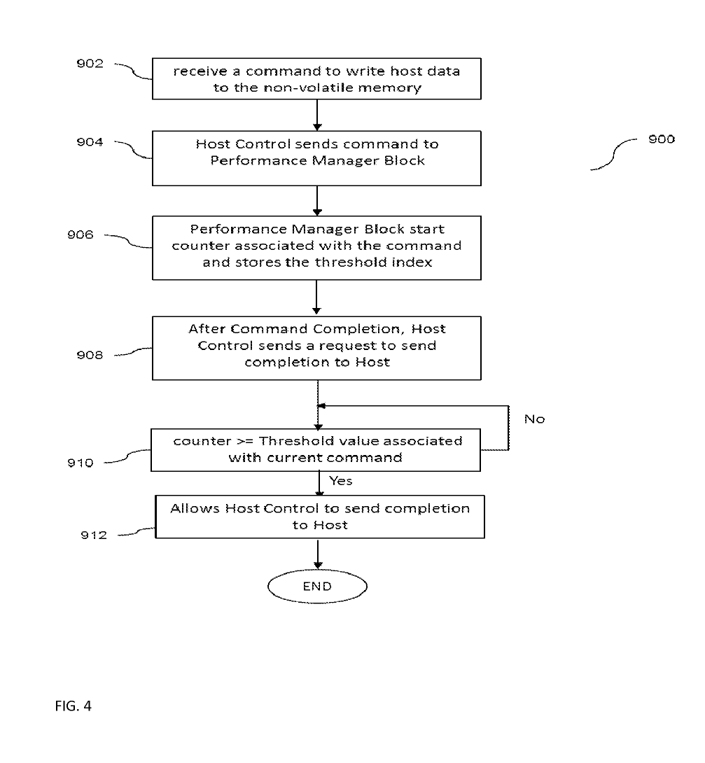

The diagram of FIG. 4 shows the flow 900 of a command using the performance manager module.

At step 902, SSD receives a write or read command from the Host. Host Control Block 500 receives and processes the command from Host; it also sends the command to the Performance Manager Block at step 904. At step 906, the Performance Manager Block checks the command and detects the type of command, read or write, and the size. Based on the size, it retrieves the correct threshold value index from the read or write command threshold block 630 or 640; Performance Manager Block also resets and enables the counter. After the Host control block detects the end of the command, it sends a request to Performance Manager Block indicating when to send the completion to host, step 910. At step 912, the Performance Manager Block compares the counter value to the threshold value. The threshold value is retrieved from 630 or 640 based on the index stored when the command arrived. The Performance Manager Block only allows the completion of a command for which the counter value is equal or longer than the threshold value, step 914. After this step, the Host Control Block sends the completion information to the Host and the command finishes.

In another embodiment, the performance manager contains a register for each command being processed by the drive. In case the Performance Manager Module receives a command from Host Control, it initializes the respective register with the Timer value added by the threshold value for the command. The Performance Manager Module can use this approach to keep track of the time interval for each of the commands currently been processed by the drive.

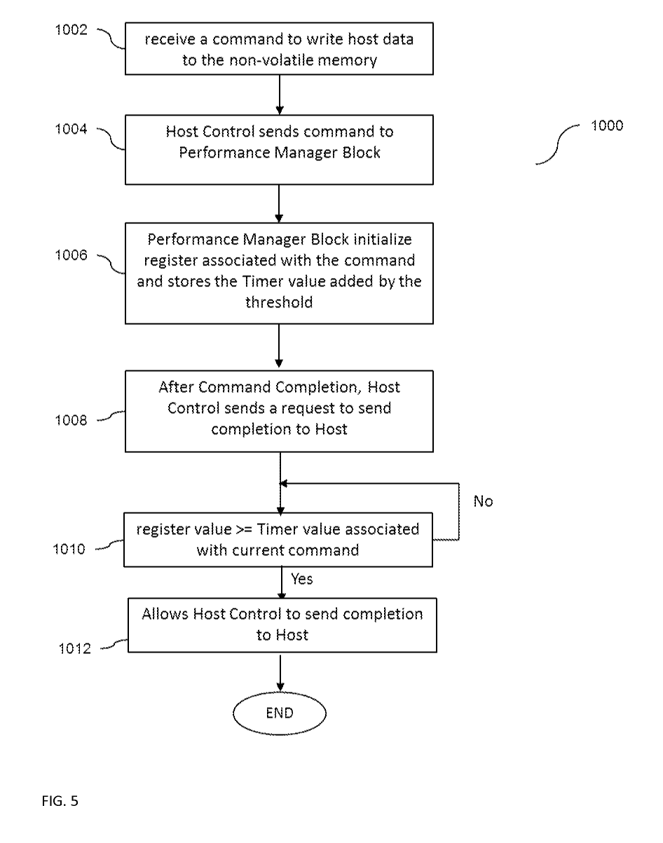

The performance manager module contains two register banks to store the threshold values depending on the command size that indicates the ideal time interval which the completion can be sent to host, depicted in blocks 630 and 640. In one embodiment, the threshold value is the worst time interval that a command can be completed which is determine during the drive characterization 800. The diagram of FIG. 5 shows the flow 1000 of a command using the performance manager module.

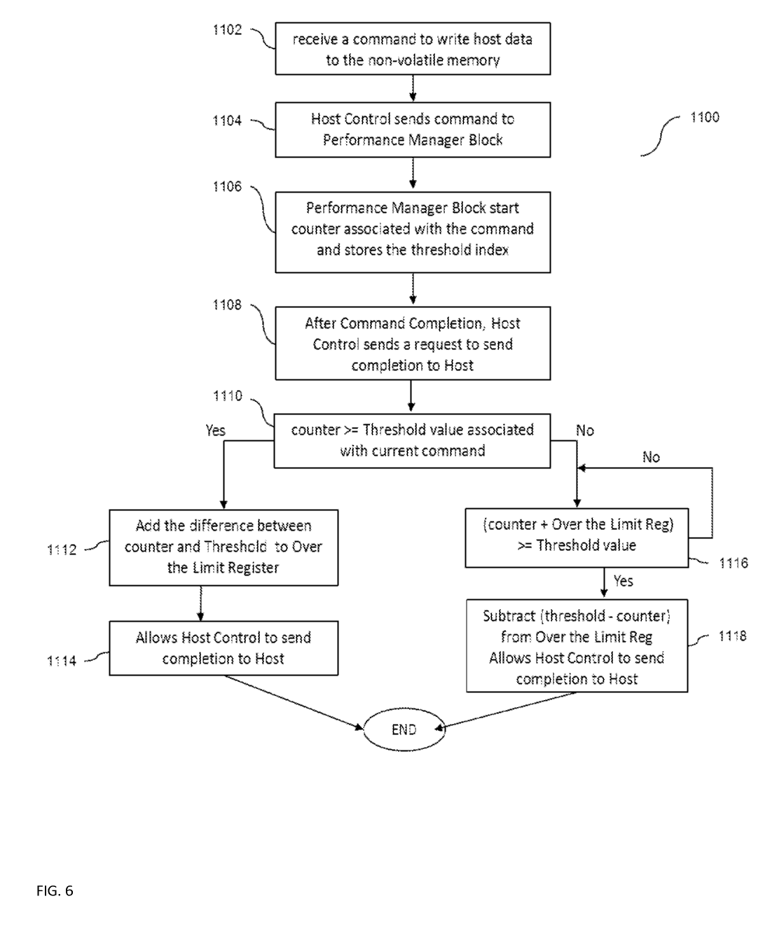

In another embodiment, the performance manager module perform a complementary action to dynamically compensate for completion time variation within a time window defined by the controller. The diagram of FIG. 6 shows the command flow 1100.

At step 1102, SSD receives a write or read command from the Host. Host Control Block 500 receives and processes the command from Host; it also sends the command to the Performance Manager Block at step 1104. At step 1106, the Performance Manager Block checks the command and detects the type of command, read or write, and the size. Based on the size, it retrieves the correct threshold value index from the read or write command threshold block 630 or 640; Performance Manager Block also resets and enables the counter. After the Host control block detects the end of the command, it sends a request to Performance Manager Block indicating when to send the completion to host, step 1108. At step 110, the Performance Manager Block compares the counter value to the threshold value. The threshold value is retrieved from 630 or 640 based on the index stored when the command arrived. If the counter value is equal or longer than the threshold, the Performance Manager Block adds the difference between the counter and the threshold to “Over the Limit” Register 650 or 660, at step 1112; then allows Host Control to send completion to Host, step 1114. If the counter value is shorter than the threshold, step 1110. At step 1116, if the counter value plus the “Over the Limit” value is equal or longer than the Threshold value then the Performance Manager Module subtracts from “Over the Limit” register the difference between the Threshold value and the counter value and then allows the Host Control to send the completion to Host, step 1118.

The Time Window Block 670 determines the time window in which the number of commands will be accumulated to measure the performance and also determines the start point in which the “Over the Limit” Register is reset. The Time Window Block is also responsible for communicate with the control block to indicate if the performance of the last time window is above or below the average.

### Advantages/Benefits of Embodiments of the Invention

An embodiment of the invention provides a mechanism to provide a consistent, reliable, and predictable performance independent on the state of the drive. The majority of the SSDs in the market provides the fastest performance possible at any given time, and consequently, they are prone to performance variations.

1. Product can be tune to customer performance requirements

2. A system utilizing this SSD can provide reliable performance independent on the state of the SSD

### Feasibility/Proof of Concept/Results Demonstration

An embodiment of the invention can be simulated using a model and demonstrate the benefits of its utilization. A SystemC model of a SSD will be modified to include the performance manager module and a comparison of a SSD with and without the embodiment of invention will be provided.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that such spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art. As used herein, the term “major component” means a component constituting at least half, by weight, of a composition, and the term “major portion”, when applied to a plurality of items, means at least half of the items.

As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present invention”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein.

Although exemplary embodiments of a system and method for providing consistent, reliable, and predictable performance in a storage device have been specifically described and illustrated herein, many modifications and variations will be apparent to those skilled in the art. Accordingly, it is to be understood that a Disclosure-System and Method For Providing Consistent, Reliable, and Predictable Performance in a Storage Device constructed according to principles of this invention may be embodied other than as specifically described herein. The invention is also defined in the following claims, and equivalents thereof.

What is claimed is:

1. An SSD storage device that uses a performance manager module.

2. The SSD of claim 1 where the performance manager module is implemented in Hardware.

3. The SSD of claim 1 where the threshold value are based on the worst case performance.

4. The SSD of claim 2 where the performance manager adjusts the completion time based on the previous command history.

5. The SSD of claim 2 where the threshold values are based on the command size.

6. The SSD of claim 2 where the threshold values are based on the command type.

7. The SSD of claim 2 where the performance manager module notifies the SSD control when the performance varies above or below a certain threshold from the average performance with a programmable window.

8. The SSD of claim 1 where the performance manager module is implemented in Firmware.

9. The SSD of claim 7 where the performance manager adjusts the completion time based on the previous command history.

10. The SSD of claim 7 where the threshold values are based on the command size.

11. The SSD of claim 7 where the threshold values are based on the command type.

12. The SSD of claim 7 where the performance manager module notifies the controller when the performance varies above or below a certain threshold from the average performance with a programmable window.
